(19) United States
(12) Patent Application Publication
(10) Pub. No.: US 2025/0298367 A1
(43) Pub. Date: Sep. 25, 2025

(54) DEVELOPING CARTRIDGE

(71) Applicant: JIANGXI YIBO E-TECH CO. LTD., Xinyu (CN)

(72) Inventors: Jian PENG, Xinyu (CN); Xiaomin GONG, Xinyu (CN); Haifeng GU, Xinyu (CN); Rongli XU, Xinyu (CN)

(21) Appl. No.: 19/230,787

(22) Filed: Jun. 6, 2025

Related U.S. Application Data
(63) Continuation-in-part of application No. PCT/CN2023/137737, filed on Dec. 9, 2023.

(30) Foreign Application Priority Data
Dec. 10, 2022 (CN) 202223305052.9
Dec. 16, 2022 (CN) 202223379543.8
Feb. 25, 2023 (CN) 202310164642.4
Apr. 15, 2023 (CN) 202320837234.6
Sep. 15, 2023 (CN) 202322519375.6
Sep. 16, 2023 (CN) 202322519416.1
Sep. 18, 2023 (CN) 202322536351.1
Oct. 7, 2023 (CN) 202322677705.4
Nov. 8, 2023 (CN) 202323016850.4

(51) Int. Cl. G03G 21/16; G03G 15/00; G03G 15/08

(52) U.S. Cl. CPC G03G 21/1652; G03G 15/0808; G03G 15/0865; G03G 15/80; G03G 21/1633

(57) ABSTRACT

A developing cartridge has a casing for accommodating developer and having a first side and a second side opposite each other in a first direction and a third side and a fourth side opposite each other in a second direction. The developing cartridge also has a rotatable input gear on the first side, for receiving a driving force; a developing roller on the third side; a chip with an electrical contact surface on the first side; and a first protrusion on the first side and having a first force receiving surface. The electrical contact surface is fixed relative to the casing. When the developing cartridge is mounted in an image forming device, the first force receiving surface may receive a force (e.g., by abutting a door cover of the image forming device), thereby moving the developing cartridge against gravity.

### TECHNICAL FIELD

The present disclosure relates to the technical field of electronic photographic imaging, and in particular to a developing cartridge.

### BACKGROUND

A developing cartridge is a cartridge that stores developer. After the developer in the developing cartridge is used up, a user can purchase a new developing cartridge and replace it by himself without the help of professionals. Moreover, the developing cartridge may be combined with a drum cartridge to be mounted in an image forming device as a whole in a detachable manner.

A developing cartridge includes a casing that can accommodate developer, a developing holder arranged at one side end of the casing, and a developing chip supported on the developing holder. The developing chip stores information such as the model of the developing cartridge and whether the developing cartridge is new or old. The developing chip may be in electrical contact with an image forming device to establish a communication connection with the image forming device. However, the developing holder may move within a limited range and stroke relative to the casing, and the developing chip supported on the developing holder may also move with the movement of the developing holder. This causes the electrical connection between the developing chip and the image forming device to become unstable, with a possibility of disconnection. Therefore, such situations are obviously undesirable for both manufacturers and users.

### SUMMARY

Disclosed herein is a developing cartridge, configured to be detachably mounted to an image forming device, the developing cartridge comprising: a casing configured to accommodate developer, the casing having a first side and a second side opposite each other in a first direction and a third side and a fourth side opposite each other in a second direction; an input gear on the first side of the casing, configured to receive a driving force from an outside of the developing cartridge and being rotatable about an input gear axis extending in the first direction; a developing roller located on the third side of the casing; a chip comprising an electrical contact surface on the first side of the casing; and a first protrusion comprising a first force receiving surface, and located on the first side of the casing. The electrical contact surface is fixed relative to the casing. When the developing cartridge is mounted in the image forming device, the first force receiving surface is configured to receive a force, thereby moving the developing cartridge against gravity. In the second direction, a distance between the first protrusion and the developing roller is greater than a distance between the first protrusion and the electrical contact surface.

In an embodiment, the first protrusion is farther away in the second direction from the developing roller than the electrical contact surface.

In an embodiment, the casing comprises a developer container for accommodating developer, and the first protrusion is spaced apart from the developer container in the first direction.

In an embodiment, the developing cartridge further comprises an electrode on the second side of the casing, and the first protrusion is farther away in the second direction from the developing roller than the electrode.

In an embodiment, the casing comprises a protective cover covering at least a part of the input gear; and the first protrusion is on a side of the protective cover away from the developing roller in the second direction.

In an embodiment, the first force receiving surface is a part of an outer surface of the protective cover.

In an embodiment, when the developing cartridge is mounted in the image forming device, the first force receiving surface is configured to abut a door cover of the image forming device, thereby moving the developing cartridge against gravity.

In an embodiment, the developing cartridge further comprises a second force receiving surface on the second side of the casing.

In an embodiment, when the developing cartridge is mounted in the image forming device, the second force receiving surface is configured to abut a door cover of the image forming device, thereby moving the developing cartridge against gravity.

In an embodiment, the developing cartridge further comprises a second protrusion configured to receive a force from an outside of the developing cartridge moving the developing cartridge at least in the second direction; and the second protrusion is farther away from the developing roller than the first protrusion in the second direction.

In an embodiment, the developing cartridge further comprises a bracket supporting the electrical contact surface; the first protrusion is on the bracket; and the electrical contact surface and the first protrusion are on opposite ends of the bracket.

In an embodiment, at least a part of the first protrusion overlaps the electrical contact surface in the first direction.

In an embodiment, at least a part of the first protrusion overlaps the electrical contact surface in the second direction.

Disclosed herein is a developing cartridge, configured to be detachably mounted to an image forming device having a door cover, the developing cartridge comprising: a casing configured to accommodate developer, the casing having a first side and a second side opposite each other in a first direction, and a third side and a fourth side opposite each other in a second direction; an input gear on the first side of the casing, configured to receive a driving force from an outside of the developing cartridge and being rotatable about an input gear axis extending in the first direction; a developing roller located on the third side of the casing; a chip comprising an electrical contact surface on the first side of the casing; and a first protrusion comprising a first force receiving surface, and located on the first side of the casing. The first protrusion is fixed relative to the casing. The electrical contact surface is fixed relative to the casing. When the developing cartridge is mounted in the image forming device, the first force receiving surface is configured to abut the door cover, thereby moving the developing cartridge against gravity.

In an embodiment, the first force receiving surface is spaced apart from the electrical contact surface in the first direction.

In an embodiment, the casing further comprises a protective cover covering at least a part of the input gear; and the first force receiving surface is a part of an outer surface of the protective cover.

In an embodiment, the developing cartridge further comprises a second force receiving surface on the second side of the casing. When the developing cartridge is mounted in the image forming device, the second force receiving surface is configured to abut the door cover of the image forming device, thereby moving the developing cartridge against gravity.

In an embodiment, the developing cartridge further comprises an second protrusion, configured to receive a force from an outside of the developing cartridge moving the developing cartridge at least in the second direction; and the second protrusion is between the first force receiving surface and the developing roller in the second direction.

In an embodiment, the developing cartridge further comprises an electrode on the second side of the casing; the second force receiving surface is farther from the developing roller than the electrode in the second direction.

### BRIEF DESCRIPTION OF FIGURES

FIG. 1 is a schematic view of a three-dimensional structure of a drum cartridge;

FIG. 2 is a schematic view of a developing cartridge in Embodiment 1 when viewed from an angle;

FIG. 3 is a schematic view of the developing cartridge in Embodiment 1 when viewed from another angle;

FIG. 4 is a schematic view of the developing cartridge in Embodiment 1 when viewed from still another angle;

FIG. 5 is a schematic view of the developing cartridge in Embodiment 1 when viewed from yet another angle;

FIG. 6 is a schematic view of the developing cartridge in Embodiment 1 when viewed from a further angle;

FIG. 7 is a schematic view of a protective cover being removed from the developing cartridge in Embodiment 1;

FIG. 8 is a schematic view of the protective cover and a gear train being removed from the developing cartridge in Embodiment 1;

FIG. 9 is a schematic view of a holder being removed from the developing cartridge in Embodiment 1;

FIG. 10 is an exploded schematic view of the holder being removed from the developing cartridge in Embodiment 1;

FIG. 11 is a schematic view of the holder in Embodiment 1 when viewed from an angle;

FIG. 12 is a schematic cross-sectional view of the holder in Embodiment 1 when viewed from an angle;

FIG. 13 is a schematic view of an electrical contact and a rib plate in an image forming device;

FIG. 14 is a schematic view of a three-dimensional structure of another drum cartridge;

FIG. 15 is a partial schematic view of still another drum cartridge;

FIG. 16 is a schematic view of a developing cartridge in Embodiment 2 when viewed from an angle;

FIG. 17 is a schematic view of the developing cartridge in Embodiment 2 when viewed from another angle;

FIG. 18 is a schematic view of the developing cartridge in Embodiment 2 when viewed from still another angle;

FIG. 19 is a schematic view of the developing cartridge in Embodiment 2 being mounted in a drum cartridge when viewed from an angle;

FIG. 20 is a schematic view of the developing cartridge in Embodiment 2 being mounted in the drum cartridge when viewed from another angle;

FIG. 21 is an enlarged view of part A in FIG. 20 in Embodiment 2;

FIG. 22 is an exploded schematic view of a developing chip and a developing holder in Embodiment 3;

FIG. 23 is a schematic view of a developing cartridge in Embodiment 4 when viewed from an angle;

FIG. 24 is a schematic view of the developing cartridge in Embodiment 4 when viewed from another angle;

FIG. 25 is an exploded schematic view of a developing chip and a developing holder in the developing cartridge in Embodiment 4;

FIG. 26 is a schematic view of an urging member of a developing cartridge in Embodiment 5 when it is located at a first position;

FIG. 27 is a schematic view of the urging member of the developing cartridge in Embodiment 5 when it is located at a third position;

FIG. 28 is a schematic view of the urging member in Embodiment 5 when it is mounted on a protective cover;

FIG. 29 is a schematic view of a developing cartridge in Embodiment 6 when viewed from an angle;

FIG. 30 is an enlarged view of part B in FIG. 29 in Embodiment 6;

FIG. 31 is a schematic view of a three-dimensional structure of an outer cover in an image forming device;

FIG. 32 is a schematic view of a developing cartridge in Embodiment 7 when viewed from an angle;

FIG. 33 is a schematic view of the developing cartridge in Embodiment 7 when viewed from another angle;

FIG. 34 is a schematic view of the developing cartridge in Embodiment 7 when viewed from still another angle;

FIG. 35 is a schematic view of a left position of the developing cartridge in Embodiment 7 in a state where an outer cover is not completely closed when the developing cartridge is mounted to an image forming device;

FIG. 36 is a schematic view of the left position of the developing cartridge in Embodiment 7 in a state where the outer cover is completely closed when the developing cartridge is mounted to the image forming device;

FIG. 37 is a schematic view of a right position of the developing cartridge in Embodiment 7 in the state where the outer cover is not completely closed when the developing cartridge is mounted to the image forming device;

FIG. 38 is a schematic view of the right position of the developing cartridge in Embodiment 7 in the state where the outer cover is completely closed when the developing cartridge is mounted to the image forming device;

FIG. 39 is a schematic view of a three-dimensional structure of a drum cartridge in Embodiment 8;

FIG. 40 is a schematic view of a three-dimensional structure of a developing cartridge in Embodiment 8;

FIG. 41 is a schematic view of a partial three-dimensional structure of a left end portion of the developing cartridge in Embodiment 8;

FIG. 42 is a schematic view of a three-dimensional structure of a movable member in Embodiment 8;

FIG. 43 is a schematic view of a left side structure of the developing cartridge, the drum cartridge and an image forming device in Embodiment 8, in a state where the movable member is located at a first position; and

FIG. 44 is a schematic view of the left side structure of the developing cartridge, the drum cartridge and the image forming device in Embodiment 8, in a state where the movable member is located at a second position.

### DETAILED DESCRIPTION

### Embodiment 1

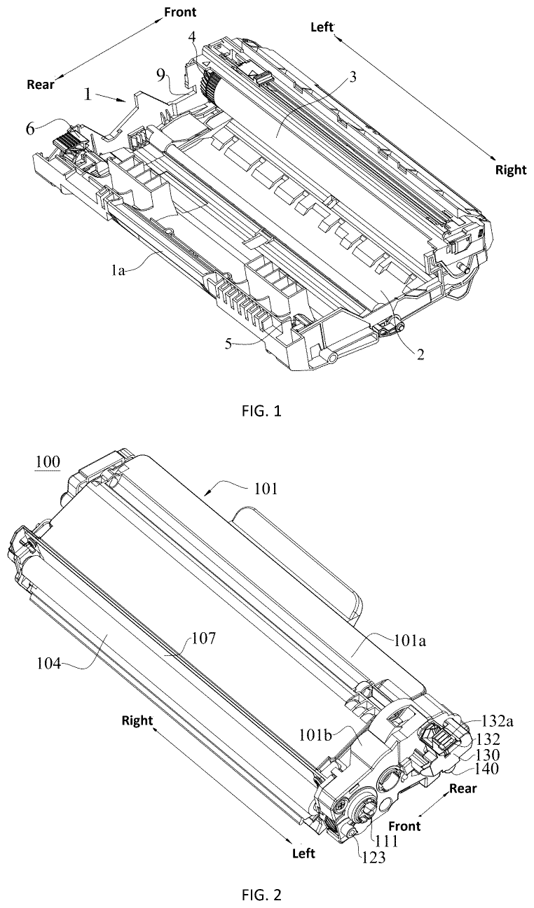

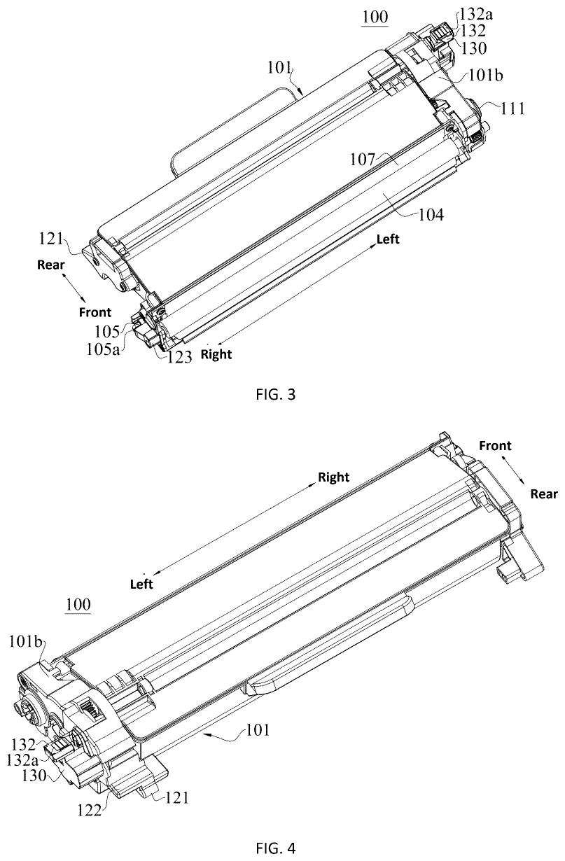

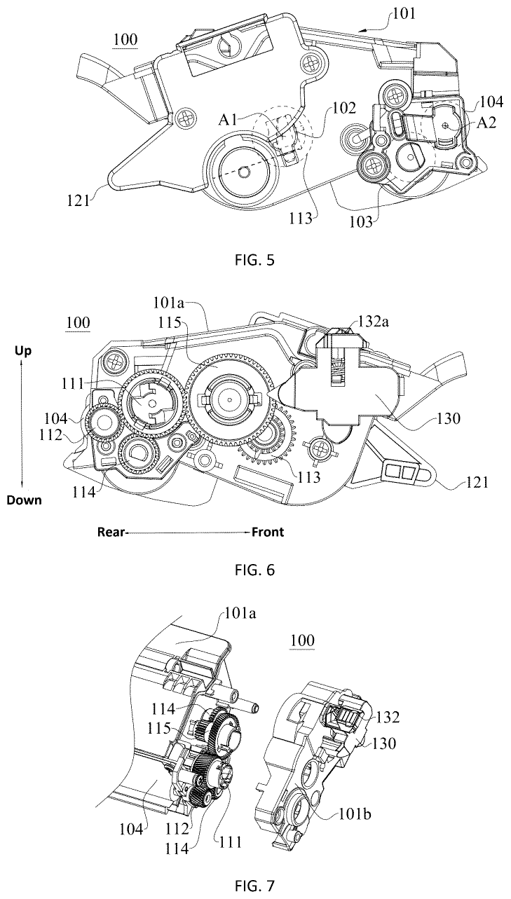

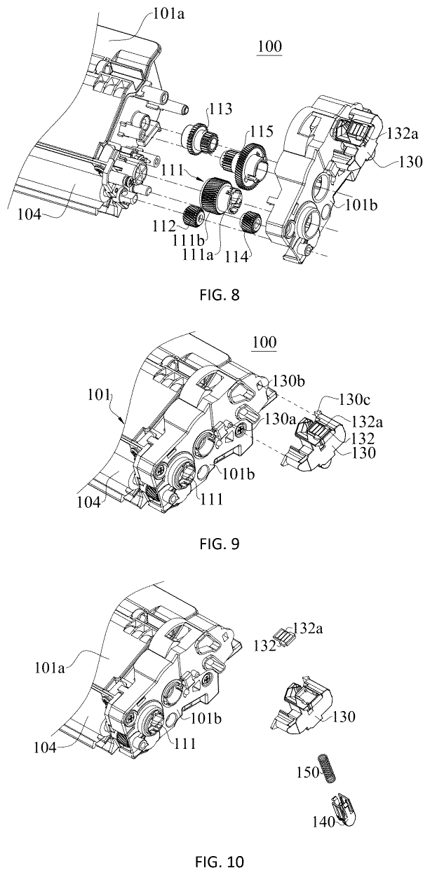

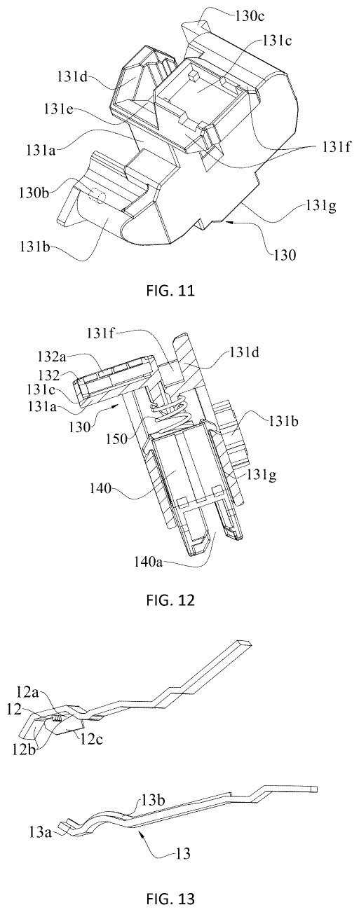

FIG. 1 shows a drum cartridge 1 in the prior art, and FIGS. 2-12 show a developing cartridge 100 in Embodiment 1. The developing cartridge 100 is detachably mounted in the drum cartridge 1, and the two may be mounted in an image forming device as a whole. With the cooperation of the two, a printing task may be performed. Next, the drum cartridge 1 and the developing cartridge 100 will be described in detail with reference to specific drawings.

### Drum Cartridge

FIG. 1 shows a drum cartridge 1. The drum cartridge 1 includes a drum frame 1a. The drum frame 1a has a developing cartridge accommodating portion 2 that accommodates a developing cartridge 100 and is configured as a cavity. A photosensitive drum 3 is arranged on the front side of the developing cartridge accommodating portion 2. The left end of the photosensitive drum 3 is connected with a photosensitive drum gear 4. The photosensitive drum gear 4 may be meshed with a gear (not shown in the figure) in an image forming device to receive a driving force to rotate, thereby driving the photosensitive drum 3 to rotate about a photosensitive drum axis extending in a left-right direction, a front-rear direction intersecting with the left-right direction. The drum cartridge 1 further includes urging assemblies 5 respectively arranged on the left and right sides of the developing cartridge accommodating portion 2. The urging assembly 5 is an elastic urging assembly that can generate an elastic urging force after being subjected to an external force. A locking member 6 is further arranged on the rear side of the urging assembly 5 on the left side of the drum cartridge 1, and the locking member 6 is not limited to a position arranged on the rear side of the urging assembly 5 on the left side of the drum cartridge 1. The locking member 6 may lock the developing cartridge 100 by blocking the movement of the developing cartridge 100 to prevent the developing cartridge 100 from being separated from the drum cartridge 1. The developing cartridge accommodating portion 2 is further provided with guide portions 9 on both sides in the left-right direction. The guide portions 9 are used to guide the developing cartridge 100 to move to a correct position in the developing cartridge accommodating portion 2, and the guide portions 9 are located between the photosensitive drum 3 and the urging assemblies 5 in the front-rear direction. When viewed along the left-right direction, the urging assemblies 5, the guide portions 9 and the photosensitive drum 3 are arranged from rear to front in the front-rear direction as a whole.

### Developing Cartridge

FIGS. 2-12 show a developing cartridge 100 in Embodiment 1. The developing cartridge 100 is detachably mounted in the drum cartridge 1 described above. The developing cartridge 100 includes a casing 101. The casing 101 includes, but is not limited to, a casing main body (developer container) 101a that can accommodate developer, and a protective cover 101b that is detachably mounted on the left side of the casing main body (developer container) 101a. The protective cover 101b may cover at least a part of a gear train of the developing cartridge 100 to protect the gear train. The gear train of the developing cartridge 100 includes, but is not limited to, a driving gear 111, a developing roller gear 112, an agitator gear 113 and a supply roller gear 114. The driving gear 111 is arranged on the left end of the casing 101, and includes a coupling portion 111a that may be coupled to an image forming device and receive driving force from the image forming device, and gear teeth 111b that are integrated with the coupling portion 111a and may be meshed with the developing roller gear 112 and the supply roller gear 114. The gear teeth 111b are meshed and connected with the developing roller gear 112 and the supply roller gear 114, respectively. The gear teeth 111b may drive the developing roller gear 112 and the supply roller gear 114 to rotate. The gear teeth 111b are connected to the agitator gear 113 through an idler gear 115. The agitator gear 113 may receive driving force of the driving gear 111 through the idler gear 115 to rotate. The developing cartridge 100 further includes an agitator 102, a supply roller 103 and a developing roller 104 supported on the casing 101, the left ends of which are connected to the agitator gear 113, the supply roller gear 114 and the developing roller gear 112, respectively. The gears may drive the agitator 102, the supply roller 103 and the developing roller 104 to rotate about their respective axes extending in the left-right direction, respectively. The developing roller 104 is arranged at the front end of the casing 101 in the front-rear direction. When the developing cartridge 100 is mounted in the drum cartridge 1, the developing roller 104 of the developing cartridge 100 keeps in contact with the photosensitive drum 3 of the drum cartridge 1. During the operation of the developing cartridge 100, the rotating agitator 102 may agitate the developer in the casing main body (developer container) 101a and convey the developer to the supply roller 103. The supply roller 103 conveys the developer to the developing roller 104 while rotating. Then, the developing roller 104 can convey the developer carried thereon to the photosensitive drum 3 by coming into contact with the photosensitive drum 3 to develop an electrostatic latent image on the photosensitive drum 3. The developing cartridge 100 is further provided with an electrode 105, which includes an electrical contact portion 105a provided at the right end of the developing cartridge 100. The electrical contact portion 105a may come into contact with and be electrically connected with a power supply component of the image forming device. The electrode 105 may receive power from the image forming device and supply power to the developing roller 104 and the supply roller 103 by electrical connection between the electrical contact portion 105a and the power supply component, so as to ensure that the developer can be stably conveyed.

The developing cartridge 100 further includes a doctor blade 107 for controlling the thickness of the developer attached to the developing roller 104. The doctor blade 107 is located between the supply roller 103 and the developing roller 104 in the front-rear direction. The doctor blade 107 is in contact with the outer circumferential surface of the developing roller 104 in the left-right direction to control the thickness of the developer attached to the developing roller 104.

The left and right ends of the developing cartridge 100 are further provided with urged protrusion (second protrusion) 121, respectively. The urged protrusion (second protrusion) 121 are formed by extending backward from the left and right sides of the bottom of the protective cover 101b, and in the front-rear direction, the urged protrusion (second protrusion) 121 are farther away from a developing roller axis A2 than the driving gear 111 and an agitator axis A1. When the developing cartridge 100 is mounted on the drum cartridge 1, the urging assemblies 5 of the drum cartridge 1 may be used to elastically urge the urged protrusion (second protrusion) 121 forward (i.e., in the direction close to the developing roller 104 or the photosensitive drum 3), so that the developing roller 104 of the developing cartridge 100 keeps close contact with the photosensitive drum 3, so as to ensure that the developer on the developing roller 104 can be normally conveyed to the photosensitive drum 3 to avoid printing quality problems. It is worth mentioning that the structure for receiving the elastic urging force is not limited to being urged by contact with the urging assemblies 5. A structure similar to the urging assemblies 5 may also be used on the developing cartridge 100 to come into contact with other components in the drum cartridge 1 for being urged, which is not a limitation. The developing cartridge 100 further includes a locked portion 122 arranged on the left side of the casing main body (developer container) 101a. The locked portion 122 is formed by extending backward from the rear end wall of the protective cover 101b, namely, extending from front to rear. The locked portion 122 may move together with the casing 101. When the developing cartridge 100 is mounted in the drum cartridge 1, the locked portion 122 may abut against the locking member 6 and be blocked to lock the developing cartridge 100 and prevent the developing cartridge 100 from being separated from the drum cartridge 1. The left and right ends of the developing cartridge 100 are further provided with guided protrusions 123, respectively, which are formed by extending outward from the left and right end walls of the protective cover 101b. When projected along the left-right direction, at least a part of the guided protrusion 123 overlaps with the developing roller 104. In other embodiments, the guided protrusion 123 may also be configured as a roller shaft of the developing roller 104 extending out of the outside of the casing 101 in the left-right direction. During the installation of the developing cartridge 100 to the drum cartridge 1, the guided protrusions 123 cooperate with the guide portions 9 to mount the developing cartridge 100 to the correct position of the developing cartridge accommodating portion 2 in the drum cartridge 1.

The developing cartridge 100 further includes a developing chip 132 arranged at the left end of the casing 101 and a holder 130 for supporting the developing chip 132. Specifically, the holder 130 is fixedly mounted on an outer side portion of the protective cover 101b. The outer side portion of the protective cover 101b is a side portion of the protective cover 101b facing the outside of the developing cartridge 100. An inner side portion of the protective cover 101b corresponds to the outer side portion. The inner side portion is a side portion of the protective cover 101b facing the casing main body (developer container) 101a. Specifically, the holder 130 is positioned by a positioning column 130a and a positioning hole 130b provided on the protective cover 101b or the holder 130 in cooperation with each other, and then is fastened to the protective cover 101b by means of an elastic buckle 130c, a screw or the like, so as to facilitate the disassembly, assembly, replacement and upgrading of the developing chip 132. In other optional embodiments, the holder 130 may also be formed by extending from the left end of the casing 101 in the left-right direction. Specifically, the holder 130 is formed by extending from the outer side portion of the protective cover from right to left. Optionally, the holder 130 may be formed by extending leftward from the left end of the casing main body (developer container) 101a; that is, the holder 130 may also be integrally formed with the protective cover 101b or the casing main body (developer container) 101a, which is not a limitation. It is sufficient to ensure that the holder 130 is fixedly mounted on the protective cover 101b to accurately support the developing chip 132 and its developing chip electrical contact surface 132a.

The developing chip 132 is supported on the holder 130. Since the holder 130 is fixedly mounted on the casing 101, the position of the holder 130 relative to the casing 101 remains fixed. Therefore, the position of the developing chip 132 supported on the holder 130 and the developing chip electrical contact surface 132a of the developing chip 132 are further restricted, and the contact with an electrical contact 12 in the image forming device described later will also be more stable. The developing chip 132 includes a developing chip electrical contact surface 132a electrically connected to the image forming device and a storage portion (not shown). The developing chip electrical contact surface 132a may be electrically connected to the electrical contact 12 of the image forming device (as shown in FIG. 13), and the storage portion stores information such as the model, newness degree, maximum number of print pages, etc. of the developing cartridge 100, and is electrically connected to the developing chip electrical contact surface 132a. When the developing cartridge 100 is mounted in the drum cartridge 1, the developing cartridge 100 establishes a communication connection with the image forming device through the electrical connection between the developing chip electrical contact surface 132a and the electrical contact 12 of the image forming device, so that the image forming device can read the information in the storage portion to determine the model, newness degree, maximum number of print pages, etc. of the developing cartridge 100. When the developer in the developing cartridge 100 is about to be used up, the image forming device may prompt users to replace it with a new developing cartridge 100 through an operation panel. Therefore, the developing cartridge 100 is provided with a developing chip 132, which can improve the level of informatization of the developing cartridge 100 and enhance the user experience. Moreover, compared with a counting gear structure in the prior art, the volume occupied by the developing chip 132 is smaller than that of the counting gear structure, which is helpful to reduce the size of the developing cartridge 100 and is advantageous for the miniaturization of the developing cartridge 100.

When the developing cartridge 100 is mounted in the drum cartridge 1, the developing chip electrical contact surface 132a of the developing cartridge 100 is located between the developing roller 104 and the urged protrusion (second protrusion) 121 in the front-rear direction, and the developing chip electrical contact surface 132a of the developing chip 132 is almost as far away from the electrical contact portion 105a of the electrode 105 as possible in the left-right direction. In addition, when measured in the front-rear direction, the distance between the electrical contact portion 105a and the developing chip electrical contact surface 132a of the developing chip 132 is greater than the distance between the electrical contact portion 105a of the electrode 105 and the developing roller 104. In this way, when the two are electrically connected to the image forming device separately, the mutual interference they are subjected to will be significantly reduced.

The holder 130 includes a main body portion 131a, a connecting portion 131b, a chip mounting groove 131c and a positioning protrusion 131d. The connecting portion 131b is connected between the main body portion 131a and the protective cover 101b, and the connecting portion 131b extends in the left-right direction, that is, the main body portion 131a, the connecting portion 131b and the protective cover 101b are arranged in sequence from left to right. The upper surface of the main body portion 131a is recessed downward to form a chip mounting groove 131c, and the developing chip 132 is mounted in the chip mounting groove 131c. A positioning protrusion 131d is formed by extending upward from the upper surface of the connecting portion 131b, and a limiting groove 131e is also formed between the main body portion 131a and the positioning protrusion 131d. The limiting groove 131e is arranged corresponding to a protrusion 12c of the image forming device, and the protrusion 12c is located on one side of the electrical contact 12 in the left-right direction. The positioning protrusion 131d and the limiting groove 131e are used to guide the installation of the developing cartridge 100 and limit the position of the holder 130, so as to ensure the contact between the developing chip electrical contact surface 132a and the electrical contact 12.

In order to ensure the stable connection between the developing chip 132 and the image forming device, the developing cartridge 100 further includes a movable member (first protrusion) 140 having a force receiving portion. The force receiving portion may receive external force so that the movable member (first protrusion) 140 drives the developing cartridge 100 to move, and the developing chip 132 and its developing chip electrical contact surface 132a can move together with the developing cartridge 100 as a whole. Specifically, after the developing cartridge 100 is mounted in the image forming device, the force receiving portion may abut against a supporting portion inside the image forming device so that the force receiving portion drives the entire developing cartridge 100 to move in the direction of making the developing chip electrical contact surface 132a come into contact with the electrical contact 12.

Specifically, as shown in FIG. 13, the interior of the image forming device is provided with the electrical contact 12 and a guide groove 12a for accommodating the electrical contact 12. The guide groove 12a is provided with side walls 12b on both sides in the front-rear direction. The interior of the image forming device is further provided with a supporting portion located below the guide groove 12a in an up-down direction, and the supporting portion is configured as a rib plate 13 extending in the front-rear direction. In this embodiment, the rib plate 13 is also configured as a guide member for guiding the developing cartridge 100 and the drum cartridge 1 to be mounted inside the image forming device.

The movable member (first protrusion) 140 may move relative to the casing 101, and the movable member (first protrusion) 140 may receive external force to drive the entire developing cartridge 100 to move. Preferably, the movable member (first protrusion) 140 is located below the holder 130 in the up-down direction, and the movable member (first protrusion) 140 is arranged in an accommodating cavity 131g provided at the bottom of the holder 130. The accommodating cavity 131g extends in the up-down direction. The movable member (first protrusion) 140 moves relative to the holder 130 along the accommodating cavity 131g in the up-down direction. A groove and a limiting block for preventing the movable member (first protrusion) 140 from being separated from the holder 130 are further provided between the holder 130 and the movable member (first protrusion) 140, but this is not a limitation. The movable member (first protrusion) 140 may also be prevented from being separated from the holder 130 by means of a long hole and a pin. An elastic member 150 is provided between the movable member (first protrusion) 140 and the holder 130, at least a part of the elastic member 150 is located inside the accommodating cavity 131g, and the elastic member 150 is preferably a compression spring. The holder 130 remains fixed relative to the casing 101, and in a state where the developing cartridge 100 is mounted in the image forming device, the movable member (first protrusion) 140 may abut against the rib plate 13 of the image forming device, so as to receive the supporting force provided by the image forming device to the movable member (first protrusion) 140 and push the developing chip electrical contact surface 132a to come into contact with the electrical contact 12 of the image forming device. This structure can also achieve the contact effect between the developing chip 132 and the electrical contact 12, thereby improving the electrical connection stability between the developing chip 132 and the electrical contact 12.

The movable member (first protrusion) 140 may move between a first position and a second position. The first position of the movable member (first protrusion) 140 is farther away from the developing chip electrical contact surface 132a in the up-down direction than the second position. The first position is the position of the movable member (first protrusion) 140 when the developing cartridge 100 is not subjected to force, and the second position is the position of the movable member (first protrusion) 140 closest to the developing chip electrical contact surface 132a. When the movable member (first protrusion) 140 is not subjected to force from the outside of the developing cartridge 100, the elastic force generated by the elastic member 150 is applied to the movable member (first protrusion) 140 and may keep the movable member (first protrusion) 140 in the first position. When the developing cartridge 100 is mounted inside the image forming device, the movable member (first protrusion) 140 of the developing cartridge 100 abuts against the rib plate 13, and the rib plate 13 applies an upward supporting force to the movable member (first protrusion) 140. Under the action of the supporting force, the movable member (first protrusion) 140 retracts inward along the cavity wall of the accommodating cavity 131g to a third position between the first position and the second position. The elastic member 150 may be compressed during the movement of the movable member (first protrusion) 140. The elastic force generated by the elastic member 150 acts on the holder 130 and drives the holder 130 to move. The developing chip 132 on the holder 130 follows the holder 130 to move toward the position where the electrical contact 12 of the image forming device is located. The developing chip electrical contact surface 132a enters the interior of the guide groove 12a and comes into contact with the electrical contact 12. Under the action of the elastic member 150, the developing chip electrical contact surface 132a of the developing chip 132 keeps in contact with the electrical contact 12 of the image forming device, which may also improve the electrical connection stability between the developing chip 132 and the electrical contact 12.

Further, during the installation of the developing cartridge 100 into the image forming device, a user pushes the developing cartridge 100 from rear to front to be mounted inside the image forming device. During this process, the holder 130 abuts against the side wall 12b of the guide groove 12a. Both sides of the holder 130 in the front-rear direction are provided with inclined surfaces 131f. Under the action of the pushing force of the user, the side wall 12b applies a downward thrust to the holder 130. At this time, the holder 130 drives the entire developing cartridge 100 to move downward, so that the developing cartridge 100 can continue to move forward over the side wall 12b under the action of the pushing force of the user. During the downward movement of the developing cartridge 100, the distance between the movable member (first protrusion) 140 and the developing chip electrical contact surface 132a becomes shorter, thereby compressing the length of the elastic member 150 so that the elastic member 150 accumulates elastic potential energy. When the developing cartridge 100 moves to the position where the developing chip electrical contact surface 132a is located below the guide groove 12a, the elastic member 150 extends to release elastic potential energy. The elastic member 150 pushes the movable member (first protrusion) 140 to move to a position further away from the developing chip electrical contact surface 132a. Under the action of the supporting force provided by the rib plate 13 for the movable member (first protrusion) 140 and the elastic force of the elastic member 150, the movable member (first protrusion) 140 drives the entire developing cartridge 100 to move in the direction of making the developing chip electrical contact surface 132a come into contact with the electrical contact 12 to move the developing cartridge 100 to a mounting position. The mounting position is a position where the developing cartridge 100 can perform imaging operations inside the image forming device. At the mounting position, the developing chip electrical contact surface 132a is in contact with the electrical contact 12 of the image forming device to establish a communication link between the developing cartridge 100 and the image forming device. The upward supporting force applied by the rib plate 13 to the movable member (first protrusion) 140 and the elastic force provided by the elastic member 150 may maintain the developing cartridge 100 with a tendency to move upward in the up-down direction, thereby maintaining the stability of the connection between the developing chip electrical contact surface 132a of the developing cartridge 100 and the electrical contact 12 inside the image forming device.

On the contrary, when the user needs to remove the developing cartridge 100 from the image forming device, the user pulls the developing cartridge 100 backward to move the developing cartridge 100 outward from front to rear. During this process, the holder 130 abuts against the side wall 12b of the guide groove 12a. Under the pulling force of the user, the side wall 12b applies a downward thrust to the holder 130. At this time, the holder 130 drives the entire developing cartridge 100 to move downward, so that the developing cartridge 100 can continue to move backward over the side wall 12b under the action of the pushing force of the user until it is separated from the image forming device.

The bottom of the movable member (first protrusion) 140 in the up-down direction is generally in a tapered shape with a larger top and a smaller bottom, and the edges and corners of the bottom of the movable member (first protrusion) 140 are all rounded to reduce the contact surface between the movable member (first protrusion) 140 and the rib plate 13 and make the contact surface between the movable member (first protrusion) 140 and the rib plate 13 smoother, so that the friction between the movable member (first protrusion) 140 and the rib plate 13 is smaller, and the developing cartridge 100 can thus be loaded to and unloaded from the image forming device more smoothly. The rib plate 13 includes a recessed portion 13a provided below the guide groove 12a, and the bottom of the movable member (first protrusion) 140 cooperates with the recessed portion 13a of the rib plate 13 to stabilize the position of the movable member (first protrusion) 140, thereby further providing stability for the contact between the developing chip electrical contact surface 132a and the electrical contact 12. A limiting groove 140a is further provided at the bottom of the movable member (first protrusion) 140, and a second rib plate 13b cooperating with the limiting groove 140a is provided at the top of the rib plate 13 to limit the movement of the movable member (first protrusion) 140 in the left-right direction. Furthermore, in order to reduce the thrust applied by the elastic member 150 to the movable member (first protrusion) 140 to avoid excessive friction between the movable member (first protrusion) 140 and the inner wall of the image forming device and thus affect the normal installation and removal of the developing cartridge 100 into the image forming device, the elastic force F applied by the elastic member 150 to the movable member (first protrusion) 140 should be less than 15 Newtons. In order to improve the user experience during the installation and removal of the developing cartridge 100, the elastic force F applied by the elastic member 150 to the movable member (first protrusion) 140 should be less than 10 Newtons. In order to ensure that the developing cartridge 100 can overcome its own gravity during the imaging process to make the developing chip electrical contact surface 132a keep in contact with the electrical contact 12, the force F applied by the elastic member 150 to the movable member (first protrusion) 140 should be greater than 4.5 Newtons in a state where the developing chip electrical contact surface 132a is connected to the electrical contact 12. In order to further ensure the stability of the contact between the developing chip electrical contact surface 132a and the electrical contact 12, the force F applied by the elastic member 150 to the movable member (first protrusion) 140 should be greater than 7.4 Newtons in the state where the developing chip electrical contact surface 132a is connected to the electrical contact 12. That is to say, in the state where the developing chip electrical contact surface 132a is connected to the electrical contact 12, the force F applied by the elastic member 150 to the movable member (first protrusion) 140 should be maintained between 4.5 Newtons and 15 Newtons. Preferably, in the state where the developing chip electrical contact surface 132a is connected to the electrical contact 12, the force F applied by the elastic member 150 to the movable member (first protrusion) 140 should be maintained between 7.4 Newtons and 10 Newtons.

More specifically, in order to realize the miniaturization of the developing cartridge 100 and make the installation and removal of the developing cartridge 100 into and from the image forming device smoother, the maximum movement S of the movable member (first protrusion) 140 is less than 6 mm. Meanwhile, in order to ensure that the developing cartridge 100 can overcome its own gravity during the imaging process to make the developing chip electrical contact surface 132a keep in contact with the electrical contact 12, in the state where the developing chip electrical contact surface 132a is connected to the electrical contact 12, the force F applied by the elastic member 150 to the movable member (first protrusion) 140 should be greater than 4.5 Newtons. Using a compression spring as an example of the elastic member 150, the elastic coefficient (F/S) of the compression spring should be greater than 0.75 N/mm.

### Embodiment 2

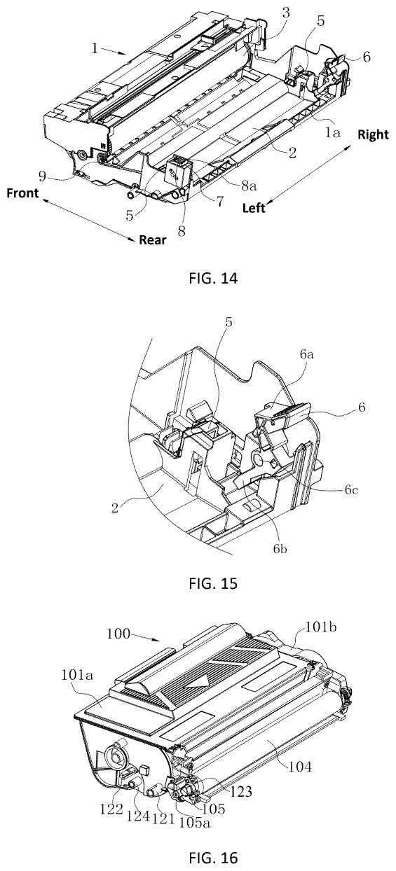

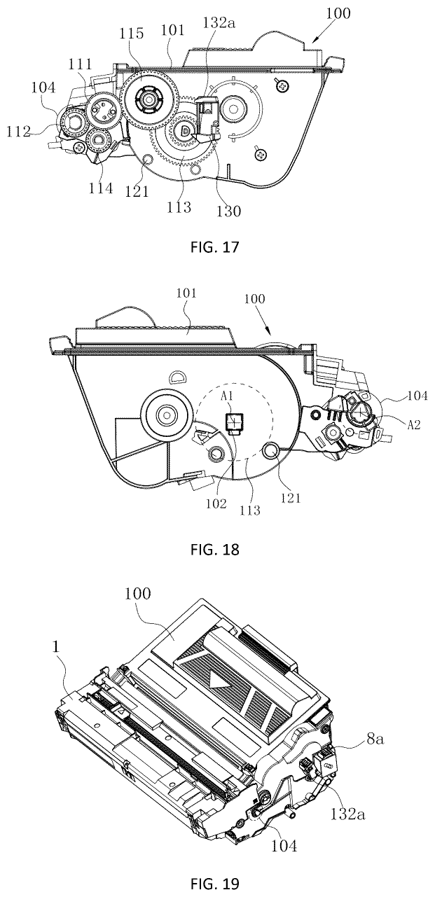

FIGS. 14-21 show a developing cartridge in Embodiment 2. The parts of the developing cartridge that are the same as the developing cartridge in Embodiment 1 described above are not described again here. The difference from Embodiment 1 described above is that: as shown in FIGS. 14-15, the locking member 6 of the drum cartridge 1 adapted to the developing cartridge 100 in this embodiment may also be arranged on the rear side of the pushing assembly 5 on the right side of the drum cartridge 1; and the locking member 6 includes a locking portion 6a and a lifting portion 6b, the locking portion 6a is arranged on the upper side closer to the drum cartridge 1 relative to the lifting portion 6b, and the locking member 6 may rotate about a shaft 6c arranged between the locking portion 6a and the lifting portion 6b. The locking portion 6a may lock the developing cartridge 100 by blocking the movement of the developing cartridge 100 to prevent the developing cartridge 100 from being separated from the drum cartridge 1. The lifting portion 6b may urge the developing cartridge 100 upward when the developing cartridge 100 needs to be removed from the drum cartridge 1, so that the locking portion 6a of the developing cartridge 100 is out of contact with the developing cartridge 100 to release the lock with the drum cartridge 1. A drum holder 7 movable relative to the drum frame 1a is further provided at the left end of the drum cartridge 1. A drum chip 8 storing various information in the drum cartridge 1 is supported on the drum holder 7. For example, the drum chip 8 stores information about the life of the drum cartridge 1 and information about whether the drum cartridge 1 is a new cartridge. The drum chip 8 has a drum chip electrical contact surface 8a provided at the left end of the drum frame 1a. Certainly, the drum chip 8 is also provided at the left end of the drum frame 1a. The drum chip electrical contact surface 8a may be in electrical contact with the drum end electrical contact (not shown in the figure) of the image forming device and may be electrically connected to the drum chip 8. The developing cartridge accommodating portion 2 is further provided with guide portions 9 on both sides in the left-right direction. The guide portions 9 are used to guide the developing cartridge 100 to move to a correct position in the developing cartridge accommodating portion 2, and the guide portions 9 are located between the photosensitive drum 3 and the urging assemblies 5 in the front-rear direction. When viewed along the left-right direction, the drum chip 8, the urging assemblies 5, the guide portions 9 and the photosensitive drum 3 are arranged from rear to front in the front-rear direction as a whole.

As shown in FIGS. 16-18, the developing cartridge 100 in this embodiment includes a locked portion 122 and a lifted protrusion 124 provided on the left side of the casing main body (developer container) 101a. The locked portion 122 and the lifted protrusion 124 are both formed by extending outward from the right end wall of the casing main body (developer container) 101a, namely, extending from left to right. In the front-rear direction intersecting the left-right direction, the urged protrusion (second protrusion) 121, the lifted protrusion 124 and the locked portion 122 are arranged in sequence from front to rear. In the front-rear direction, the urged protrusion (second protrusion) 121 is located between the developing chip electrical contact surface 132a and the driving gear 111. The urged protrusion (second protrusion) 121, the locked portion 122 and the lifted protrusion 124 may all move together with the casing 101. When the developing cartridge 100 is mounted in the drum cartridge 1, the locked portion 122 may abut against the locking portion 6a of the locking member 6 and be blocked to lock the developing cartridge 100 to prevent the developing cartridge 100 from being separated from the drum cartridge 1. When the developing cartridge 100 needs to be removed from the drum cartridge 1, the locking member 6 may be pressed downward to rotate the locking member 6 about the shaft 6c, and then the lifting portion 6b may urge the lifted protrusion 124 of the developing cartridge 100 upward to lift the developing cartridge 100, so that the locked portion 122 of the developing cartridge 100 is out of contact with the locking portion 6a of the locking member 6 to unlock the developing cartridge. At this time, even if an operator no longer presses the locking member 6, the operator may freely remove the developing cartridge 100 from the drum cartridge 1. Therefore, the provision of the lifted protrusion 124 can facilitate the user to remove the developing cartridge 100 from the drum cartridge 1. However, in some embodiments, the lifted protrusion 124 may also be omitted, which does not affect the cooperation between the developing cartridge 100 and the drum cartridge 1 and the printing quality. When removing the developing cartridge 100, it is only necessary to press the locking member 6 and remove the developing cartridge 100 at the same time until the locking portion 6a of the locking member 6 can no longer block the locked portion 122 of the developing cartridge 100.

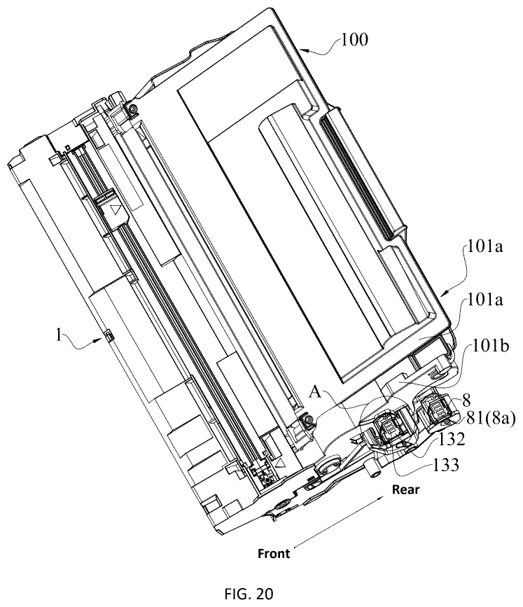

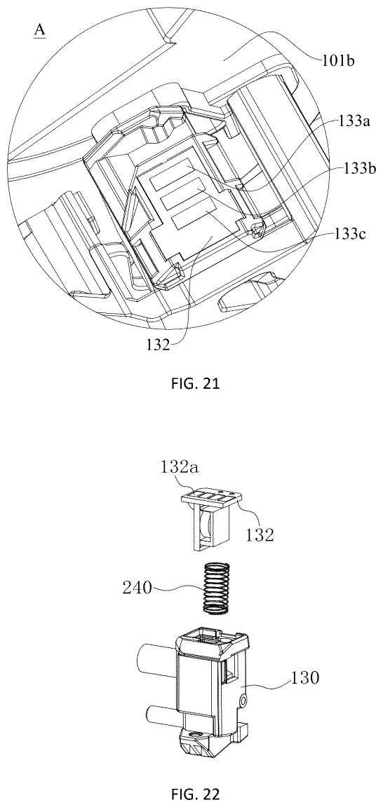

As shown in FIGS. 20-21, the developing chip electrical contact surface 132a is composed of a plurality of contacts 133 as conductors, and the plurality of contacts 133 are arranged in the left-right direction. When the developing cartridge 100 is mounted in the image forming device, the developing chip electrical contact surface 132a is in contact with the electrical contact 12 of the image forming device, so that the electrical contact 12 is connected to the developing chip electrical contact surface 132a, thereby enabling the image forming device to read information from the developing chip 132 and write information to the developing chip 132.

Specifically, the contact 133 includes a VCC (power) contact 133a, a DATA (data) contact 133b, and a GND (ground) contact 133c. The plurality of contacts are arranged from right to left in the left-right direction in accordance with the VCC (power) contact 133a, the DATA (data) contact 133b, and the GND (ground) contact 133c, that is, the VCC (power) contact 133a is closest to the casing 101, the GND (ground) contact 133c is farthest from the casing 101, and the DATA (data) contact 133b is located between the VCC (power) contact 133a and the GND (ground) contact 133c in the left-right direction.

The drum chip 8 in the drum cartridge 1 has a drum chip electrical contact surface 8a electrically connected to a drum contact (not shown) in the image forming device. Similar to the developing chip electrical contact surface 132a in the developing chip 132, the drum chip electrical contact surface 8a is composed of a plurality of drum contacts 81 as conductors, and the plurality of drum contacts 81 are arranged in the left-right direction. In the state where the developing cartridge 100 is mounted in the drum cartridge 1, the drum contact 81 at the leftmost end in the left-right direction of the drum chip electrical contact surface 8a is farther away from the casing 101 than the GND (ground) contact 133c in the developing chip 132, that is, the drum contact 81 at the leftmost end in the left-right direction of the drum chip electrical contact surface 8a is located on the left side of the GND (ground) contact 133c in the left-right direction.

Further, when the drum cartridge 1 and the developing cartridge 100 are mounted in the image forming device, the drum chip 8 is spaced on the rear side of the developing chip 132 in the front-rear direction, and the drum chip 8 is spaced above the developing chip 132 in the up-down direction, thereby avoiding mutual interference between the two groups of storage chips during the installation of the drum cartridge 1 and the developing cartridge 100 in the image forming device.

Specifically, when the developing cartridge 100 is mounted in the drum cartridge 1, the developing chip electrical contact surface 132a of the developing cartridge 100 is located between the developing roller 104 and the drum chip electrical contact surface 8a of the drum cartridge 1 in the front-rear direction, and the developing chip electrical contact surface 132a of the developing chip 132 is farther away from the casing main body (developer container) 101a relative to the agitator gear 113 in the left-right direction, that is, the developing chip electrical contact surface 132a is provided closer to the outside of the casing main body (developer container) 101a relative to the agitator gear 113 in the left-right direction, which can avoid the interference between the developing chip electrical contact surface 132a and gears such as the agitator gear 113 to the greatest extent. Moreover, such an arrangement also makes the developing chip electrical contact surface 132a of the developing chip 132 almost as far away from the electrical contact portion 105a of the electrode 105 in the left-right direction as possible. In this way, the mutual interference between the two when they are electrically connected to the image forming device separately will be significantly reduced.

### Embodiment 3

FIG. 22 shows a developing cartridge in Embodiment 3. The parts of the developing cartridge that are the same as the developing cartridges in Embodiments 1-2 described above are not described again here. The difference is that an elastic member 240 may also be provided between the developing chip 132 and the holder 130. The elastic member 240 is preferably a compression spring. When the developing chip 132 is not subjected to force from outside the developing cartridge, the elastic force generated by the elastic member 240 is applied to the developing chip 132 to keep the developing chip 132 in the first position. When the developing chip 132 is subjected to force from outside the developing cartridge 100 (that is, it comes into contact with the electrical contact 12 of the image forming device and is pressed), the developing chip 132 may overcome the elastic force of the elastic member 240 to move downward from the first position to the second position. At this time, the developing chip electrical contact surface 132a of the developing chip 132 keeps in elastic contact with the electrical contact 12 of the image forming device. Even if it is impossible for the developing cartridge 100 to come into contact with the electrical contact of the image forming device in an ideal state due to manufacturing errors or installation errors of the developing cartridge 100, the developing chip 132 may move relative to the holder 130 because of the provision of the elastic member 240, thereby adaptively coming into contact with the electrical contact 12 of the image forming device, which greatly improves the stability of the electrical connection between the developing chip 132 and the electrical contact of the image forming device. Optionally, in some embodiments, the developing chip 132 does not have to move as a whole relative to the holder 130 or the casing 101, and the developing chip electrical contact surface 132a may also be provided to be separated from the storage portion. The two are connected by a flexible printed circuit board. The elastic member 240 is provided between the developing chip electrical contact surface 132a and the holder 130, which can only force the developing chip electrical contact surface 132a to move. Such a structure can also achieve the same technical effect as the movement of the entire developing chip 132 described above, which is also not a limitation.

### Embodiment 4

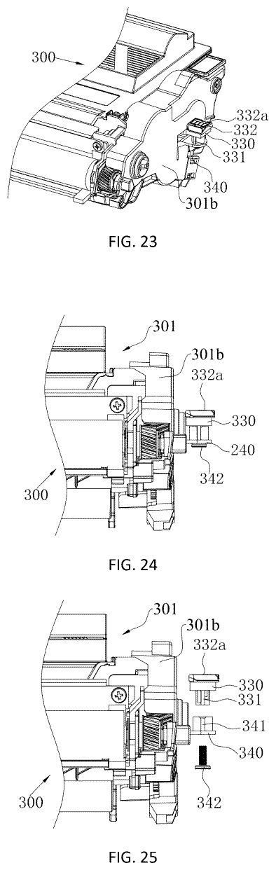

FIGS. 23-25 show a developing cartridge 300 in Embodiment 4. The parts of the developing cartridge 300 that are the same as the developing cartridges in Embodiments 1-3 described above are not described again here. The difference is that the developing chip 332 of the developing cartridge 300 is fixedly mounted in the developing holder 330, that is, the developing chip 332 does not move relative to the developing holder 330, but one end of the developing holder 330 in this embodiment is elastically connected to the casing 301. Preferably, one end of the developing holder 330 is elastically connected to the protective cover 301b. Specifically, an elastic member 340 integrally formed with the protective cover 301b is provided on the right end portion of the protective cover 301b. The elastic member 340 is configured as a spring sheet extending outward from the protective cover 301b, and the developing holder 330 is fastened to the spring sheet by, for example, a screw 342. Therefore, the developing holder 330 remains fixed relative to the protective cover 301b, that is, the developing holder 330 remains fixed relative to the casing 301. When the developing chip electrical contact surface 332a of the developing chip 332 comes into contact with the electrical contact 12 of the image forming device and is pressed, the pressing force is transmitted to the elastic member 340, forcing the elastic member 340 to undergo elastic deformation. Such a structure can also achieve the contact effect of elastic contact between the developing chip 332 and the electrical contact 12, thereby improving the stability of the electrical connection between the developing chip 332 and the electrical contact 12.

In order to accurately determine the mounting position of the developing holder 330, and to prevent the developing holder 330 from moving or rotating in a direction intersecting with the pressed direction of the developing chip 332 after being subjected to external force, a rib 331 extending along the pressed direction of the developing chip 332 is provided on the developing holder 330, and a groove 341 matched therewith is provided on the elastic member 340. The rib 331 of the developing holder 330 may be mounted in the groove 341 of the elastic member 340 in a matched manner, so that the developing holder 330 is accurately positioned, thereby ensuring that the developing chip 332 can accurately come into contact with the electrical contact 12. Optionally, a groove may be provided on the developing holder 330, and a rib may be provided on the elastic member 340. The accurate positioning of the developing holder 330 may also be achieved through the cooperation of the groove and the rib. Moreover, the positioning structure is not limited to the structure of the groove and the rib described above, and may also be mounted on the elastic member 340 by means of interference fit.

It is worth mentioning that in order to further improve the stability of the elastic contact between the developing chip 332 and the electrical contact of the image forming device, the developing chip 332 in this embodiment may also be the same as the developing chip in Embodiment 3, with an elastic member being arranged between the developing chip 332 and the developing holder 330, so that the developing chip electrical contact surface 332a of the developing chip 332 is movable relative to the developing holder.

### Embodiment 5

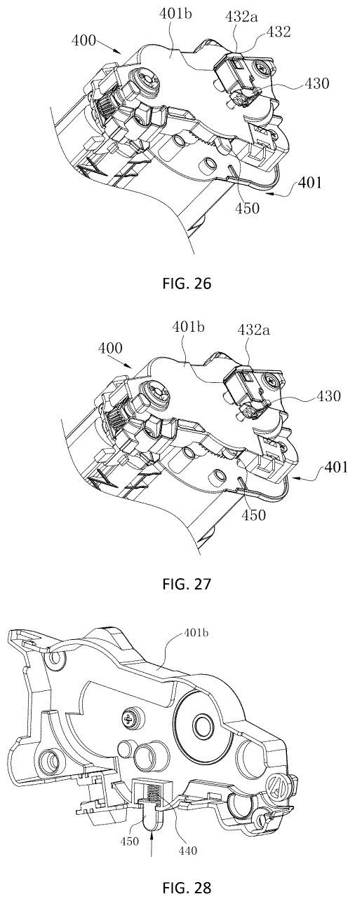

FIGS. 26-28 show a developing cartridge 400 in Embodiment 5. The parts of the developing cartridge 400 that are the same as the developing cartridges in Embodiments 1˜4 described above are not described again here. The difference is that the structure on the developing cartridge 400 for forcing the developing chip 432 to come into elastic contact with the electrical contact 12 of the image forming device is different, as shown in FIGS. 26-28. Specifically, the developing holder 430 in this embodiment is fixedly mounted on the protective cover 401b, and the developing chip 432 is also fixedly mounted in the developing holder 430, so that the positions of the developing holder 430 and the developing chip 432 relative to the casing 401 are fixed. The developing cartridge 400 further includes an urging member (first protrusion) 450 movably mounted on the lower side of the protective cover 401b (that is, the side facing the drum cartridge 1 when the developing cartridge 400 is mounted in the drum cartridge 1), and the urging member (first protrusion) 450 may move relative to the protective cover 401b in the up-down direction. An elastic member 440 is provided between the urging member (first protrusion) 450 and the protective cover 401b. The elastic member 440 is preferably a compression spring. When the urging member (first protrusion) 450 is not subjected to force from outside the developing cartridge 400, the elastic force generated by the elastic member 440 is applied to the urging member (first protrusion) 450 and may keep the urging member (first protrusion) 450 in a first position. When the urging member (first protrusion) 450 is subjected to thrust from outside the developing cartridge 400, that is, when the developing cartridge 400 is mounted in the drum cartridge 1, the urging member (first protrusion) 450 abuts against the inner wall of the drum cartridge 1. Under the action of the installation force applied by the user to the developing cartridge 400, the urging member (first protrusion) 450 may overcome the elastic force of the elastic member 440 to retract inward to a second position. The urging member (first protrusion) 450 in the second position is closer to the developing chip electrical contact surface 432a of the developing chip 432 than at least a part of the urging member (first protrusion) 450 in the first position, so that the developing cartridge 400 and the drum cartridge 1 can be smoothly mounted in the image forming device. When the developing cartridge 400 and the drum cartridge 1 are mounted in the image forming device together, the elastic member 440 releases the elastic force, so that the urging member (first protrusion) 450 drives the developing cartridge 400 to move in the direction of making the developing chip electrical contact surface 432a of the developing chip 432 closer to the electric contacts 12. At this time, the developing chip electrical contact surface 432a of the developing chip 432 keeps in elastic contact with the electric contacts 12 of the image forming device, which can also improve the stability of the electrical connection between the developing chip 432 and the electric contacts.

It is worth mentioning that in order to further improve the stability of the elastic contact between the developing chip 432 and the electrical contact 12 of the image forming device, the developing chip 432 in this embodiment may also be the same as the developing chip in Embodiment 3, with an elastic member being arranged between the developing chip 432 and the developing holder 430, so that the developing chip electrical contact surface 432a of the developing chip 432 is movable relative to the developing holder 430.

### Embodiment 6

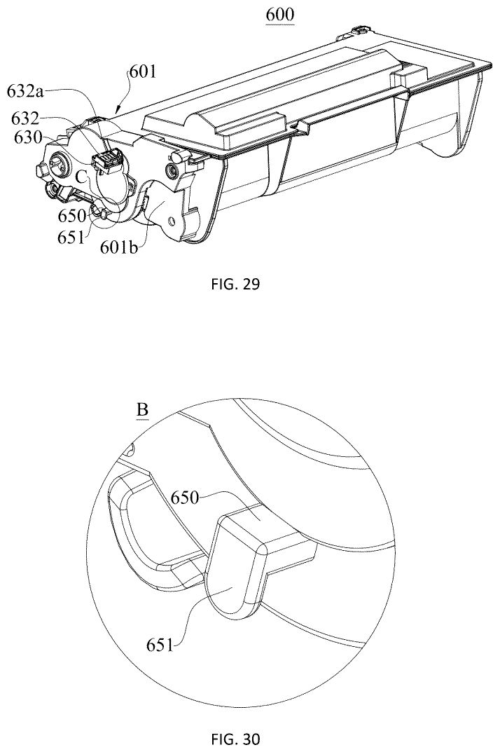

FIGS. 29-30 show a developing cartridge 600 in Embodiment 6. The same parts as the developing cartridges in Embodiments 1-5 described above are not described again here. The difference from Embodiments 1-5 described above is that a lifting protrusion (first protrusion) 650 is provided at the left end portion of the developing cartridge 600. During the installation of the developing cartridge 600 together with the drum cartridge 1 to the image forming device, one end of the lifting protrusion (first protrusion) 650 receives a force from the image forming device to push the developing cartridge 600 to move upward. At this time, the developing holder 630, the developing chip 632 supported thereon, and the developing chip electrical contact surface 632a move upward with the developing cartridge 600 and come into contact with the electrical contact 12, so that the developing chip electrical contact surface 632a is electrically connected to the electrical contact 12, and the developing cartridge 600 thus establishes a communication link with the image forming device.

Specifically, the lifting protrusion (first protrusion) 650 is provided on the outer side of the protective cover 601b away from the casing main body 601, and the lifting protrusion (first protrusion) 650 is “L”-shaped. In the left-right direction, a rib plate 13 is provided on the left side of the interior of the image forming device (as shown in FIG. 13), and the electrical contact 12 are arranged above the rib plate 13 in the up-down direction. The rib plate 13 includes an inclined surface facing backward, namely, in the direction from rear to front, the inclined surface extending from bottom to top. Before performing imaging operations, the developing cartridge 600 needs to be first mounted to the drum cartridge 1, and then mounted together with the drum cartridge 1 into the interior of the image forming device. During the installation of the developing cartridge 600 together with the drum cartridge 1 to the image forming device, the user pushes the developing cartridge 600 and the drum cartridge 1 from rear to front to mount them into the interior of the image forming device, and the lifting protrusion (first protrusion) 650 is located above the rib plate 13. Under the continuous push of the user, the lifting protrusion (first protrusion) 650 abuts against the inclined surface of the rib plate 13. Under the continuous push of the user, the lifting protrusion (first protrusion) 650 supports the developing cartridge 600 to move upward relative to the drum cartridge 1, and the developing chip electrical contact surface 632a moves upward around the developing roller shaft with the developing cartridge 600, and comes into contact with the electrical contact 12 to establish an electrical connection between the developing chip electrical contact surface 632a and the electrical contact 12, thereby establishing a communication link between the developing cartridge 600 and the image forming device to realize the communication connection between the developing cartridge 600 and the image forming device.

Optionally, the lifting protrusion (first protrusion) 650 may also be provided on the right side of the developing cartridge 600, and a rib plate 13 is correspondingly provided on the right side of the interior of the image forming device. Optionally, lifting protrusions 650 may also be provided on the left and right sides of the developing cartridge 600, and the developing cartridge 600 is simultaneously supported on both the left and right sides, making the movement of the developing cartridge 600 more stable.

It is worth mentioning that, similarly to Embodiment 1 described above, in order to make the developing chip electrical contact surface 632a of the developing chip 632 have higher positioning accuracy, that is, to ensure that the developing chip electrical contact surface 632a can easily come into contact with the electric contacts 12 after the developing cartridge 600 is mounted in the image forming device, a guide groove 12a is further provided inside the image forming device, the guide groove 12a has an opening facing downward, and the electric contacts 12 are provided inside the guide groove 12a. During the installation of the developing cartridge 600 into the interior of the image forming device by the user, a force receiving end 651 of the lifting protrusion (first protrusion) 650 of the developing cartridge 600 abuts against the rib plate 13, and the lifting protrusion (first protrusion) 650 is subjected to an upward reaction force. After being subjected to the force, the lifting protrusion (first protrusion) 650 drives the developing cartridge 600 to move upward, so that the developing chip electrical contact surface 632a enters the interior of the guide groove 12a and comes into contact with the electric contacts 12, thereby realizing accurate and stable connection between the developing chip electrical contact surface 632a and the electric contacts 12.

In order to further improve the stability of the elastic contact between the developing chip 632 and the electrical contact of the image forming device, the developing chip 632 in this embodiment may also be the same as the developing chip in Embodiment 3, with an elastic member being arranged between the developing chip 632 and the developing holder 630, so that the developing chip electrical contact surface 632a of the developing chip 632 is movable relative to the developing holder.

Furthermore, a roller may be provided at the bottom of the lifting protrusion (first protrusion) 650, which is connected to the rib plate 13 in a rolling manner, thereby reducing the resistance received by the developing cartridge 600 and making the installation of the developing cartridge 600 smoother.

### Embodiment 7

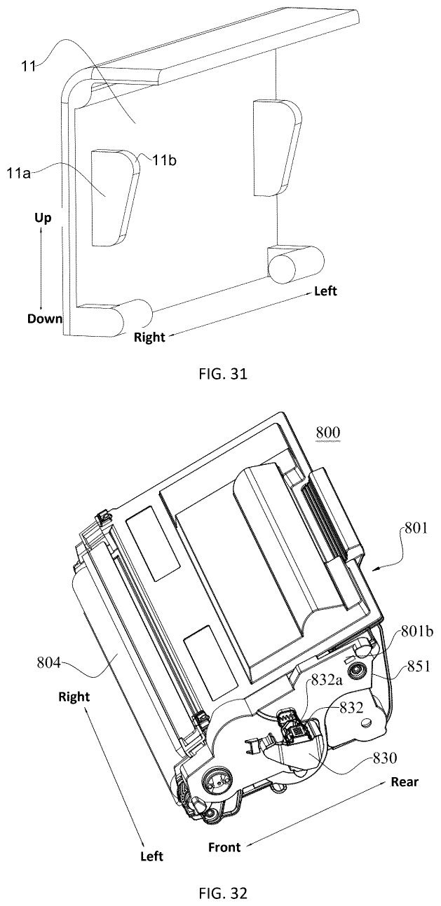

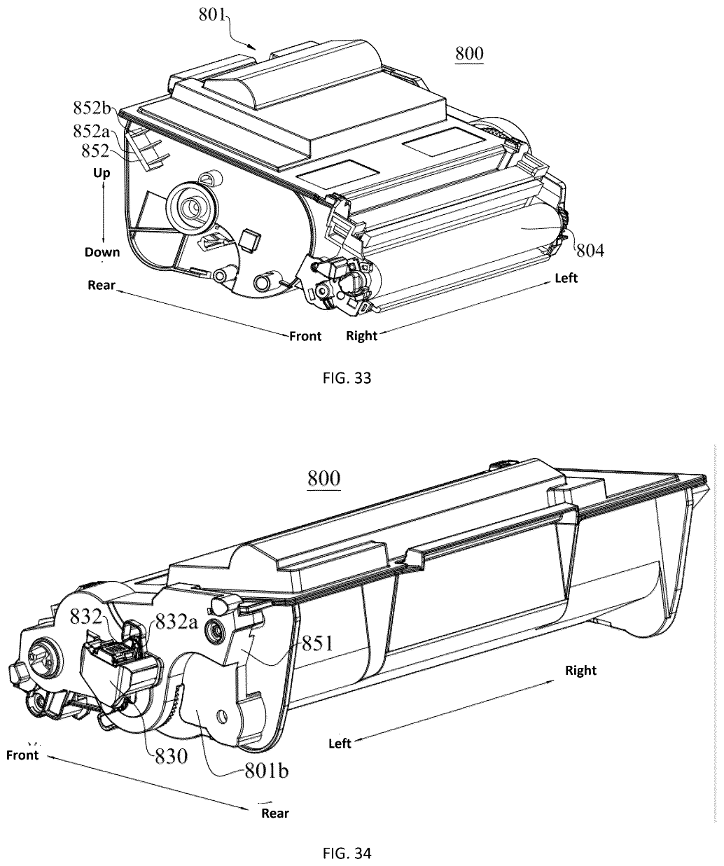

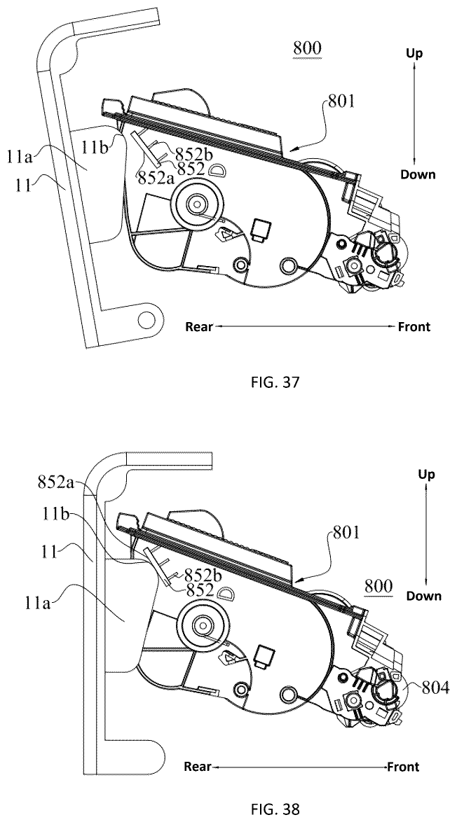

FIGS. 31-38 show a developing cartridge 800 in Embodiment 7. The same parts as the developing cartridges in the above embodiments are not described again here. The difference from the above embodiments is that the interior of the image forming device includes a mounting cavity for mounting the developing cartridge 800 and the drum cartridge 1, an outer cover (door cover) 11 is provided at the exit of the mounting cavity, and an electrical contact 12 that can be connected to the developing chip electrical contact surface 832a is provided inside the mounting cavity. The developing cartridge 800 is provided with an abutting portion on one side in the left-right direction. After the developing cartridge 800 is mounted in the image forming device, the abutting portion may abut against the outer cover (door cover) 11 of the image forming device and receive the thrust of the outer cover (door cover) 11 to drive the developing cartridge 800 to move inside the image forming device, so that the developing chip electrical contact surface 832a of the developing cartridge 800 comes into contact with the electrical contact 12, and the developing cartridge 800 thus establishes a communication connection with the image forming device.

Specifically, a reinforcing plate 11a is provided on the inner side of the outer cover (door cover) 11 in the image forming device, and the reinforcing plate 11a includes a supporting surface 11b facing the upper front. The abutting portion is configured as an abutting surface (first force receiving surface) 851 of the first protrusion provided at the rear end of the protective cover 801b on the left side of the developing cartridge 800, the abutting surface (first force receiving surface) 851 extends in the left-right direction, and the abutting surface (first force receiving surface) 851 is obliquely toward the rear and downward. In the left-right direction, the reinforcing plate 11a at least partially overlaps with the abutting surface (first force receiving surface) 851.

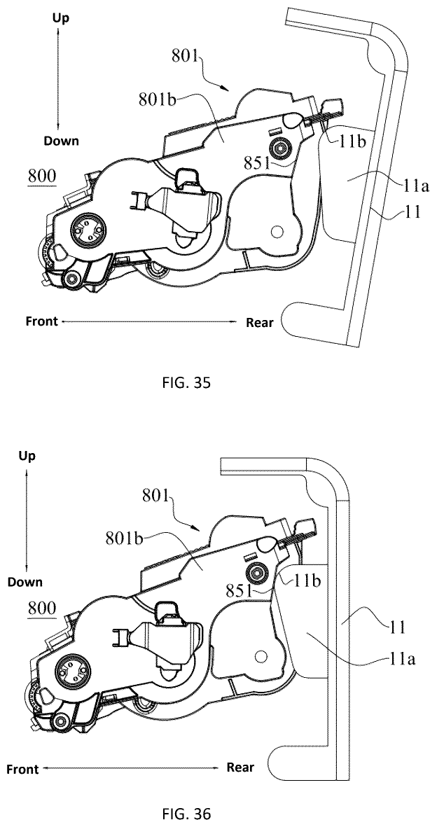

During the installation of the developing cartridge 800 to the image forming device, the developing cartridge 800 moves from rear to front toward the interior of the image forming device and enters the interior of the mounting cavity of the image forming device. At this time, as shown in FIG. 35, the developing chip electrical contact surface 832a of the developing chip 832 of the developing cartridge 800 is spaced below the electrical contact 12. Thereafter, the user rotates the outer cover (door cover) 11 upward and fixes the outer cover (door cover) 11 at the exit of the accommodating cavity through a locking member (not shown) provided between the main body portion of the image forming device and the outer cover (door cover) 11. As shown in FIG. 36, during the upward rotation of the outer cover (door cover) 11, the reinforcing plate 11a of the outer cover (door cover) 11 comes into contact with the abutting surface (first force receiving surface) 851 and applies a thrust to the abutting surface (first force receiving surface) 851. After the abutting surface (first force receiving surface) 851 is subjected to the thrust, under the action of the thrust, the abutting surface (first force receiving surface) 851 drives the developing cartridge 800 to rotate upward about an axis of the developing roller 804, the developing chip electrical contact surface 832a rotates upward about the axis of the developing roller together with the developing cartridge 800, and comes into contact with the electrical contact 12 to establish an electrical connection between the developing chip electrical contact surface 832a and the electrical contact 12, thereby establishing a communication link between the developing cartridge 800 and the image forming device to achieve a communication connection between the developing cartridge 800 and the image forming device. Further, when the outer cover (door cover) 11 is locked at the opening of the accommodating cavity, the supporting surface 11b of the outer cover (door cover) 11 abuts against the abutting surface (first force receiving surface) 851, and the supporting surface 11b applies an upward reaction force to the abutting surface (first force receiving surface) 851, thereby maintaining a stable contact between the developing chip electrical contact surface 832a and the electrical contact 12, and further ensuring a stable communication connection between the developing cartridge 800 and the image forming device.

Optionally, in other implementations of this embodiment, the abutting portion is configured as an abutting plate 852 extending outward from the right side of the casing 801, and the abutting plate 852 includes a second abutting surface (second force receiving surface) 852a facing rearward and downward, and a reinforcing rib 852b arranged at the upper front of the abutting plate 852. Similarly to those in the above implementations, after the developing cartridge 800 is mounted in the image forming device, the outer cover (door cover) 11 rotates upward, so that the supporting surface 11b of the reinforcing plate 11a abuts against the second abutting surface (second force receiving surface) 852a and applies a thrust to the second abutting surface (second force receiving surface) 852a. After the second abutting surface (second force receiving surface) 852a is subjected to the thrust, under the action of the thrust, the second abutting surface (second force receiving surface) 852a drives the developing cartridge 800 to rotate upward about the axis of the developing roller 804, and the developing chip electrical contact surface 832a rotates upward about the axis of the developing roller together with the developing cartridge 800, so that the developing cartridge 800 establishes a communication link with the image forming device to achieve a communication connection between the developing cartridge 800 and the image forming device.

Preferably, in another implementation of this embodiment, abutting surfaces 851 and abutting plates 852 are provided on the left and right sides of the developing cartridge 800, respectively. Correspondingly, the outer cover (door cover) 11 includes the reinforcing plate 11a, the reinforcing plate 11a includes two plates respectively adapted to the abutting surfaces 851 and the second abutting surfaces 852a of the developing cartridge 800. During the upward rotation of the outer cover (door cover) 11, the two plates are in contact with the abutting surfaces 851 and the second abutting surfaces 852a, respectively, thereby further improving the stability of the contact between the developing chip electrical contact surface 832a and the electrical contact 12.

It is worth mentioning that in order to make the developing chip electrical contact surface 832a of the developing chip 832 have higher positioning accuracy, that is, to ensure that the developing chip electrical contact surface 832a may easily come into contact with the electrical contact 12 after the developing cartridge 800 is mounted in the image forming device, a guide groove 12a is further provided inside the image forming device (as shown in FIG. 13), the guide groove 12a has an opening facing downward, and the electrical contact 12 is provided inside the guide groove 12a. When the user installs the developing cartridge 800 into the image forming device, the developing chip electrical contact surface 832a is located below the guide groove 12a in the up-down direction. Thereafter, the user pushes the outer cover (door cover) 11 to move upward to close the image forming device, the outer cover (door cover) 11 abuts against the force receiving end of the abutting surface (first force receiving surface) 851, and applies a forward force to the force receiving end. The abutting surface (first force receiving surface) 851 is subjected to the force and then drives the developing cartridge 800 to move upward, so that the developing chip electrical contact surface 832a enters the guide groove 12a and comes into contact with the electrical contact 12, thereby achieving the accurate and stable connection between the developing chip electrical contact surface 832a and the electrical contact 12.

In order to further improve the stability of the elastic contact between the developing chip 832 and the electrical contact 12 of the image forming device, the developing chip 832 in this embodiment may also be the same as the developing chip in Embodiment 3, with an elastic member being arranged between the developing chip 832 and the developing holder 830, so that the developing chip electrical contact surface 832a of the developing chip 832 is movable relative to the developing holder 830.

### Embodiment 8

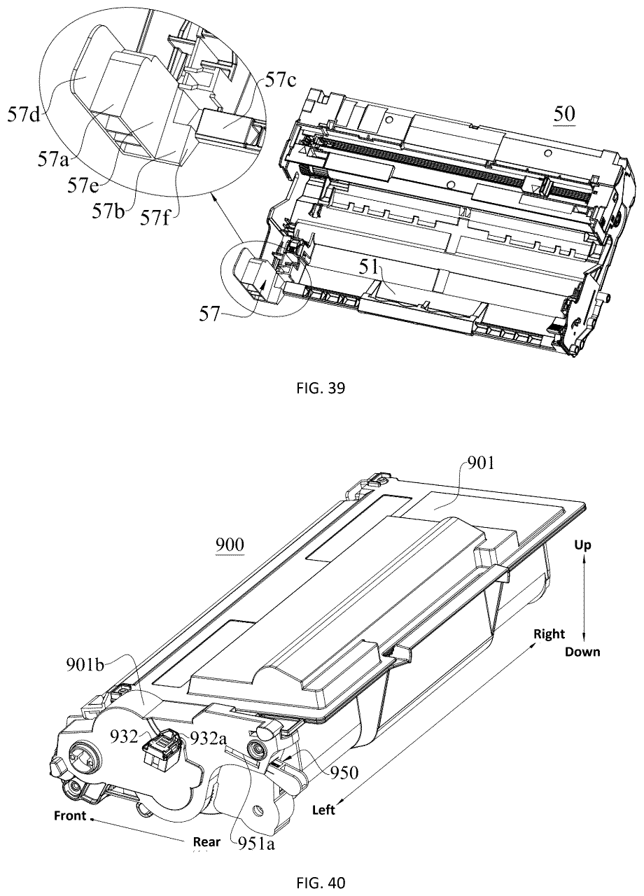

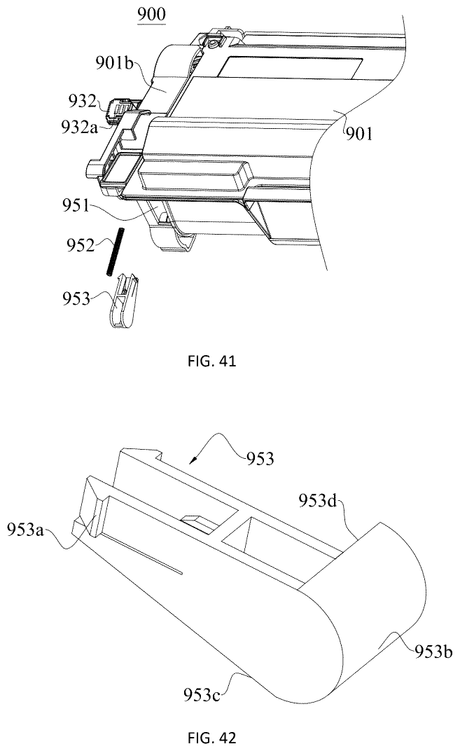

FIGS. 39-44 show a developing cartridge 900 in Embodiment 8. The same parts as the developing cartridges in the above embodiments are not described again here. The difference from the above embodiments is that the left side of the inner part of the drum frame 51 in the drum cartridge 50 is provided with a step surface 57, and the step surface 57 includes a plurality of action surfaces facing upward in the up-down direction. The developing cartridge 900 is provided with a lifting portion 950. After the developing cartridge 900 is mounted in the image forming device, the lifting portion 950 is simultaneously subjected to the thrust of the outer cover (door cover) 11 in the image forming device and the supporting force of the step surface 57 in the drum cartridge 50, so that the lifting portion 950 drives the developing cartridge 900 and the developing chip electrical contact surface 932a provided thereon to move upward in the up-down direction and make the developing chip electrical contact surface 932a come into contact with the electrical contact 12 of the image forming device, so as to ensure that the electrical connection between the developing chip electrical contact surface 932a and the electrical contact 12 in the image forming device is stable, thereby ensuring the stability of the communication link between the developing cartridge 900 and the image forming device.

The rear side of the casing 901 in the developing cartridge 900 is recessed inward to form a mounting groove 951. Specifically, the rear side of the protective cover 901b located on the left side of the casing main body 901a is recessed inward to form the mounting groove 951. The interior of the mounting groove 951 is provided with a movable member (first protrusion) 953 and an elastic member 952 connected between the movable member (first protrusion) 953 and the protective cover 901b. The mounting groove 951 extends in the front-rear direction, and the movable member (first protrusion) 953 may slide in the front-rear direction along the mounting groove 951. The movable member (first protrusion) 953 has a limiting portion 953a, a force receiving portion (first force receiving surface) 953b and a supported portion 953c. The limiting portion 953a cooperates with an auxiliary groove 951a of the mounting groove 951 to prevent the movable member (first protrusion) 953 from being separated from the mounting groove 951. After the developing cartridge 900 is mounted in the image forming device, the force receiving portion (first force receiving surface) 953b of the movable member (first protrusion) 953 comes into contact with the outer cover (door cover) 11 of the image forming device. Specifically, the force receiving portion (first force receiving surface) 953b comes into contact with the reinforcing plate 11a of the outer cover (door cover) 11, and a forward thrust in the front-rear direction is applied to the force receiving portion (first force receiving surface) 953b, so that the movable member (first protrusion) 953 slides from rear to front relative to the casing 901. During the sliding process of the movable member (first protrusion) 953 from rear to front, the supported portion 953c of the movable member (first protrusion) 953 comes into contact with the step surface 57 of the drum cartridge 50, so that the movable member (first protrusion) 953 is subjected to a supporting force of the step surface 57. Under the action of the supporting force, the movable member (first protrusion) 953 drives the developing cartridge 900 to move upward, so that the developing chip electrical contact surface 932a comes into contact with the electrical contact 12, thereby ensuring a stable electrical connection between the developing cartridge 900 and the image forming device.

Further, the force receiving portion (first force receiving surface) 953b is configured as a contact surface extending in the left-right direction to ensure that the reinforcing plate 11a comes into contact with the force receiving portion (first force receiving surface) 953b when the developing cartridge 900 is mounted in the image forming device. Furthermore, the movable member (first protrusion) 953 includes an extending portion 953d extending in the left-right direction from the side of the movable member (first protrusion) 953 to expand the contactable area of the force receiving portion (first force receiving surface) 953b, thereby ensuring that the movable member (first protrusion) 953 can stably obtain the thrust from the image forming device to maintain the supporting effect of the lifting portion 950 on the developing cartridge 900. In the state where the developing cartridge 900 is mounted in the drum cartridge 50, the movable member (first protrusion) 953 at least partially overlaps with the step surface 57 in the left-right direction, that is, the supported portion 953c at least partially overlaps with the step surface 57 in the left-right direction, thereby ensuring that when the developing cartridge 900 is mounted in the image forming device, the supported portion 953c can come into contact with the step surface 57, and the step surface 57 can thus apply a supporting force to the supported portion 953c.

The step surface 57 includes a first action surface 57a, a second action surface 57b and a third action surface 57c, and a first side surface 57d, a second side surface 57e and a third side surface 57f for connecting a plurality of action surfaces. In the up-down direction, the first action surface 57a, the second action surface 57b and the third action surface 57c are arranged in sequence from top to bottom, and in the left-right direction, the first action surface 57a, the second action surface 57b and the third action surface 57c are arranged in sequence from left to right. The plurality of action surfaces are may be used to cooperate with the movable member (first protrusion) 953 to drive the developing cartridge 900 to move upward. With the first action surface 57a as an example, in the state where the developing cartridge 900 is mounted in the drum cartridge 50, the supported portion 953c of the movable member (first protrusion) 953 at least partially overlaps with the first action surface 57a in the left-right direction. When the movable member (first protrusion) 953 is subjected to the thrust of the outer cover (door cover) 11 and slides from rear to front along the mounting groove 951, the supported portion 953c of the movable member (first protrusion) 953 comes into contact with a first action surface 57a, so that the movable member (first protrusion) 953 is subjected to a supporting force of the first action surface 57a. Under the action of the supporting force, the movable member (first protrusion) 953 drives the developing cartridge 900 to move upward, so that the developing chip electrical contact surface 932a comes into contact with the electrical contact 12, thereby ensuring a stable electrical connection between the developing cartridge 900 and the image forming device. Further, the plurality of side surfaces may also be set as a beveled surface facing rearward and upward, and cooperate with the movable member (first protrusion) 953 to support the movable member (first protrusion) 953 to drive the developing cartridge 900 to move upward.

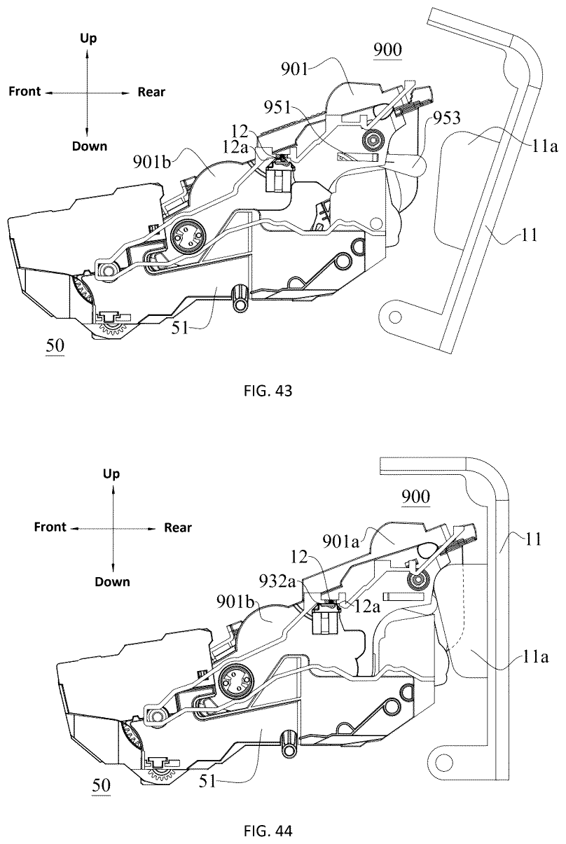

The process of installing the developing cartridge 900 into the image forming device will be described in detail below. As shown in FIGS. 43-44, during use, the user installs the developing cartridge 900 into the interior of the image forming device from rear to front. At this time, the movable member (first protrusion) 953 is in a first position as shown in FIG. 43, and the developing chip 932 and its developing chip electrical contact surface 932a are located below the guide groove 12a. Thereafter, the user pushes the outer cover (door cover) 11 to rotate upward, so that the reinforcing plate 11a of the outer cover (door cover) 11 comes into contact with the force receiving portion (first force receiving surface) 953b of the movable member (first protrusion) 953. Under the continuous push of the user, the reinforcing plate 11a applies a forward thrust to the force receiving portion (first force receiving surface) 953b, so that the movable member (first protrusion) 953 slides from the first position to a second position as shown in FIG. 44 along the mounting groove 951 in a roughly front-rear direction from rear to front. During the sliding process of the movable member (first protrusion) 953, the supported portion 953c of the movable member (first protrusion) 953 abuts against the first action surface 57a, and under the continuous push of the user, the movable member (first protrusion) 953 is supported between the drum frame 51 of the drum cartridge 50 and the casing 901, that is, the supported portion 953c is subjected to a supporting force of the first action surface 57a. The supporting force is transmitted to the casing 901 through the contact between the upper surface of the movable member (first protrusion) 953 and the upper wall of the mounting groove 951, so that the movable member (first protrusion) 953 drives the developing cartridge 900 to move upward. During the upward movement process of the developing cartridge 900, the developing chip electrical contact surface 932a enters the interior of the guide groove 12a and comes into contact with the electrical contact 12, so that the developing chip electrical contact surface 932a is electrically connected to the electrical contact 12, thereby establishing a communication link between the developing cartridge 900 and the image forming device. In a state where the developing cartridge 900 and the image forming device are working, the outer cover (door cover) 11 is locked on one side of the developing cartridge 900. Therefore, the reinforcing plate 11a of the outer cover (door cover) 11 always maintains a thrust on the movable member (first protrusion) 953, and then the movable member (first protrusion) 953 is maintained between the first action surface 57a and the casing 901, so as to maintain a stable electrical connection between the developing chip electrical contact surface 932a and the electrical contact 12, thereby avoiding the occurrence of communication interruption between the developing cartridge 900 and the image forming device.

When the developing cartridge 900 needs to be replaced from the image forming device, the user opens the outer cover (door cover) 11. At this time, the thrust received by the movable member (first protrusion) 953 disappears. Under the action of the elastic member 952, the movable member (first protrusion) 953 returns from the second position to the first position. The developing cartridge 900 moves downward under the action of gravity, so that the developing chip 932 leaves the guide groove 12a, making it convenient for the user to take out the developing cartridge 900 and replace it with a new developing cartridge 900 for reuse. The elastic member 952 is preferably a spring.

Further, the length of the movable member (first protrusion) 953 in the up-down direction is gradually shortened from its rear end in the front-rear direction to its front end in the front-rear direction. When the movable member (first protrusion) 953 is subjected to a forward thrust, it facilitates the abutment between the movable member (first protrusion) 953 and the first action surface 57a. At this time, the movable member (first protrusion) 953 provides an upward force to the casing 901 to drive the developing cartridge 900 to move upward.

### Beneficial Effects

The developing holder may be fixed on the casing so that the position of the developing holder relative to the casing does not change, thereby avoiding the problem that the developing chip supported on the developing holder is disconnected from the electrical contact of the image forming device due to shaking, and improving the stability of the electrical connection between the developing chip and the electrical contact.

What is claimed is:

1. A developing cartridge, configured to be detachably mounted to an image forming device, the developing cartridge comprising:
a casing configured to accommodate developer, wherein the casing has a first side and a second side opposite each other in a first direction, and a third side and a fourth side opposite each other in a second direction;
an input gear on the first side of the casing, configured to receive a driving force from an outside of the developing cartridge and being rotatable about an input gear axis extending in the first direction;
a developing roller located on the third side of the casing;
a chip comprising an electrical contact surface on the first side of the casing; and
a first protrusion comprising a first force receiving surface, and located on the first side of the casing;
wherein the electrical contact surface is fixed relative to the casing;
wherein, when the developing cartridge is mounted in the image forming device, the first force receiving surface is configured to receive a force, thereby moving the developing cartridge against gravity;
wherein, in the second direction, a distance between the first protrusion and the developing roller is greater than a distance between the first protrusion and the electrical contact surface.

2. The developing cartridge according to claim 1, wherein the first protrusion is farther away in the second direction from the developing roller than the electrical contact surface.

3. The developing cartridge according to claim 1, wherein the casing comprises a developer container for accommodating developer, and the first protrusion is spaced apart from the developer container in the first direction.

4. The developing cartridge according to claim 1, further comprising an electrode on the second side of the casing;
wherein the first protrusion is farther away in the second direction from the developing roller than the electrode.

5. The developing cartridge according to claim 1, wherein the casing comprises a protective cover covering at least a part of the input gear; and
wherein the first protrusion is on a side of the protective cover away from the developing roller in the second direction.

6. The developing cartridge according to claim 5, wherein the first force receiving surface is a part of an outer surface of the protective cover.

7. The developing cartridge according to claim 1, wherein, when the developing cartridge is mounted in the image forming device, the first force receiving surface is configured to abut a door cover of the image forming device, thereby moving the developing cartridge against gravity.

8. The developing cartridge according to claim 1, further comprising a second force receiving surface on the second side of the casing.

9. The developing cartridge according to claim 8, wherein, when the developing cartridge is mounted in the image forming device, the second force receiving surface is configured to abut a door cover of the image forming device, thereby moving the developing cartridge against gravity.

10. The developing cartridge according to claim 1, further comprising a second protrusion configured to receive a force from an outside of the developing cartridge moving the developing cartridge at least in the second direction; and
wherein the second protrusion is farther away from the developing roller than the first protrusion in the second direction.

11. The developing cartridge according to claim 1, further comprising a bracket supporting the electrical contact surface, wherein the first protrusion is on the bracket; and
wherein the electrical contact surface and the first protrusion are on opposite ends of the bracket.

12. The developing cartridge according to claim 1, wherein at least a part of the first protrusion overlaps the electrical contact surface in the first direction.

13. The developing cartridge according to claim 1, wherein at least a part of the first protrusion overlaps the electrical contact surface in the second direction.

14. A developing cartridge, configured to be detachably mounted to an image forming device having a door cover, the developing cartridge comprising:
a casing configured to accommodate developer, wherein the casing has a first side and a second side opposite each other in a first direction, and a third side and a fourth side opposite each other in a second direction;
an input gear on the first side of the casing, configured to receive a driving force from an outside of the developing cartridge and being rotatable about an input gear axis extending in the first direction;
a developing roller located on the third side of the casing;
a chip comprising an electrical contact surface on the first side of the casing; and
a first protrusion comprising a first force receiving surface, and located on the first side of the casing;
wherein the first protrusion is fixed relative to the casing,
wherein the electrical contact surface is fixed relative to the casing; and
wherein, when the developing cartridge is mounted in the image forming device, the first force receiving surface is configured to abut the door cover, thereby moving the developing cartridge against gravity.

15. The developing cartridge according to claim 14, wherein the first force receiving surface is spaced apart from the electrical contact surface in the first direction.

16. The developing cartridge according to claim 14, wherein the casing further comprises a protective cover covering at least a part of the input gear; and
wherein the first force receiving surface is a part of an outer surface of the protective cover.

17. The developing cartridge according to claim 14, further comprising a second force receiving surface on the second side of the casing,
wherein, when the developing cartridge is mounted in the image forming device, the second force receiving surface is configured to abut the door cover of the image forming device, thereby moving the developing cartridge against gravity.

18. The developing cartridge according to claim 14, further comprising a second protrusion, configured to receive a force from an outside of the developing cartridge moving the developing cartridge at least in the second direction; and
wherein the second protrusion is between the first force receiving surface and the developing roller in the second direction.

19. The developing cartridge according to claim 17, further comprising an electrode on the second side of the casing;
wherein the second force receiving surface is farther from the developing roller than the electrode in the second direction.
